(19) United States
(12) Patent Application Publication
(10) Pub. No.: US 2020/0208271 A1
(43) Pub. Date: Jul. 2, 2020

(54) VEHICLE COMPONENT AND METHOD FOR MANUFACTURING THE SAME

(71) Applicant: TOYOTA JIDOSHA KABUSHIKI KAISHA, Toyota-shi (JP)

(72) Inventor: Yoshihiro IWANO, Toyota-shi (JP)

(73) Assignee: TOYOTA JIDOSHA KABUSHIKI KAISHA, Toyota-shi (JP)

(21) Appl. No.: 16/672,603

(22) Filed: Nov. 4, 2019

(30) Foreign Application Priority Data
Dec. 26, 2018 (JP) 2018-243324

(51) Int. Cl. C23C 18/31; C23C 18/16

(52) U.S. Cl. CPC C23C 18/31; B60R 13/04; C23C 18/165; C23C 18/1641

(57) ABSTRACT

A vehicle component having excellent heat resistance, excellent optical resistance, and excellent scratch resistance is provided. A vehicle component according to an aspect of the present disclosure includes a silver mirror layer and a top coat layer formed on a substrate. The top coat layer includes a first top coat part formed on the silver mirror layer, a second top coat part forming an outermost part of the top coat layer, and a colored top coat part disposed between the first and second top coat parts, the colored top coat part being mixed with paint.

### CROSS REFERENCE TO RELATED APPLICATIONS

This application is based upon and claims the benefit of priority from Japanese patent application No. 2018-243324, filed on Dec. 26, 2018, the disclosure of which is incorporated herein in its entirety by reference.

### BACKGROUND

The present disclosure relates to a vehicle component and a method for manufacturing a vehicle component. For example, the present disclosure relates to a vehicle component in which a silver mirror layer and a top coat layer are formed on a substrate, and a method for manufacturing such a vehicle component.

In recent years, there have been cases where a silver mirror layer is formed on a surface of a vehicle component in order to improve an external appearance of the vehicle component. For example, a vehicle component disclosed in Japanese Unexamined Patent Application Publication No. 2014-128906 has an integrated structure of a resin layer and a sheet for decorative molding formed of a silver mirror layer and a top coat layer. This integrated structure is obtained by injection-molding a resin (i.e., a raw material of the resin layer) on the rear surface of the sheet for decorative molding. That is, the vehicle component disclosed in Japanese Unexamined Patent Application Publication No. 2014-128906 has a structure in which the silver mirror layer and the top coat layer are formed on the resin layer.

### SUMMARY

The present inventors have found the following problem. A coating of a vehicle component needs to have heat resistance for suppressing (i.e., reducing) the transfer of heat to a substrate, optical resistance to ultraviolet light and the like, and scratch resistance. The vehicle component disclosed in Japanese Unexamined Patent Application Publication No. 2014-128906 includes a silver mirror layer formed on a resin layer, which serves as a substrate, and hence it is possible to suppress the transfer of heat to the resin layer. Further, the vehicle component disclosed in Japanese Unexamined Patent Application Publication No. 2014-128906 includes a top coat layer formed on the silver mirror layer and hence it is possible to prevent the surface of the vehicle component from being scratched. However, in the vehicle component disclosed in Japanese Unexamined Patent Application Publication No. 2014-128906, there is a problem that since ultraviolet light and the like reaches the silver mirror layer through the top coat layer, the silver mirror layer deteriorates.

The present disclosure has been made in view of the above-described problem and provides a vehicle component having excellent heat resistance, excellent optical resistance, and excellent scratch resistance, and a method for manufacturing such a vehicle component.

A first exemplary aspect is a vehicle component including a silver mirror layer and a top coat layer formed on a substrate, in which

the top coat layer includes:

a first top coat part formed on the silver mirror layer;

a second top coat part forming an outermost part of the top coat layer; and

a colored top coat part disposed between the first and second top coat parts, the colored top coat part being mixed with paint.

Since the above-described vehicle component includes the colored top coat part formed on the silver mirror layer, it is possible to prevent sunlight from being incident on the silver mirror layer, and thereby preventing ultraviolet light and the like from being incident on the silver mirror layer. In addition, since the silver mirror layer is formed on the substrate, it is possible to suppress the transfer of heat to the substrate. Further, since the top coat layer is formed on the substrate, it is possible to prevent the surface of the vehicle component from being scratched. Therefore, the vehicle component has excellent heat resistance, excellent optical resistance, and excellent scratch resistance.

In the above-described vehicle component, the second top coat part preferably has higher elasticity than that of the first top coat part.

As a result, when the second top coat part is pressed, it is elastically deformed in a satisfactory manner. Therefore, it is possible to prevent the surface of the second top coat part from being scratched, and thereby preventing the surface of the vehicle component from being scratched.

Another exemplary aspect is a method for manufacturing a vehicle component including a silver mirror layer and a top coat layer formed on a substrate, the method including:

when the top coat layer is formed,

forming a first top coat part on the silver mirror layer;

forming a colored top coat part on the first top coat part, the colored top coat part being mixed with paint; and

forming, as an outermost part of the top coat layer, a second top coat part on the colored top coat part.

In the above-described method for manufacturing a vehicle component, the colored top coat part is formed on the silver mirror layer. Therefore, it is possible to prevent sunlight from being incident on the silver mirror layer, and thereby preventing ultraviolet light and the like from being incident on the silver mirror layer. In addition, since the silver mirror layer is formed on the substrate, it is possible to suppress the transfer of heat to the substrate. Further, since the top coat layer is formed on the substrate, it is possible to prevent the surface of the vehicle component from being scratched. Therefore, it is possible to manufacture vehicle components having excellent heat resistance, excellent optical resistance, and excellent scratch resistance.

In the above-described method for manufacturing a vehicle component, the substrate is preferably a cast-molded article molded from a urethane-based resin.

As a result, it is possible to manufacture a small number of vehicle components at a low cost.

In the above-described method for manufacturing a vehicle component, the silver mirror layer is preferably formed by a silver-mirror plating method.

As a result, it is possible to manufacture a small number of vehicle components at a low cost.

In the above-described method for manufacturing a vehicle component, the silver mirror layer and the top coat layer are preferably formed on a part of the substrate, and another coating is preferably applied to another part of the substrate.

In this way, it is possible to easily apply different types of coatings to different parts of the vehicle component.

According to the present disclosure, it is possible to provide a vehicle component having excellent heat resistance, excellent optical resistance, and excellent scratch resistance, and a method for manufacturing such a vehicle component.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a flowchart showing a method for manufacturing a vehicle component according to a first embodiment;

FIG. 2 schematically shows a vehicle component according to the first embodiment;

FIG. 3 is a cross section of a vehicle component formed by the method for manufacturing a vehicle component according to the first embodiment; and

FIG. 4 schematically shows a vehicle component according to a second embodiment.

### DESCRIPTION OF EMBODIMENTS

Specific embodiments to which the present disclosure is applied are described hereinafter in detail with reference to the drawings. However, the present disclosure is not limited to the below-shown embodiments. Further, the following description and drawings are simplified as appropriate for clarifying the explanation.

### First Embodiment

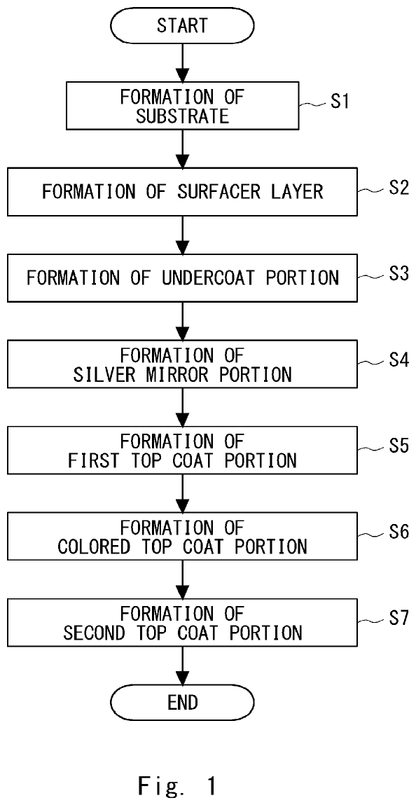

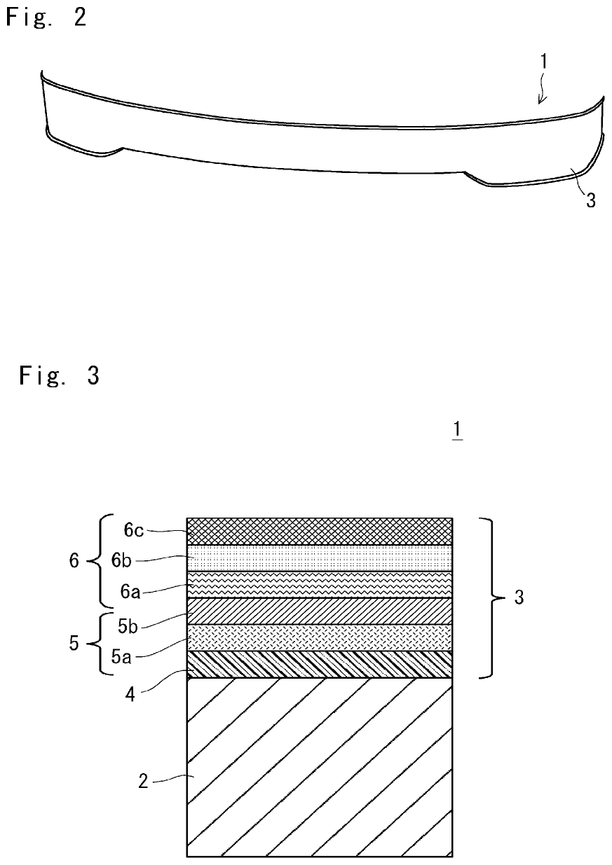

FIG. 1 is a flowchart of a method for manufacturing a vehicle component according to this embodiment. FIG. 2 schematically shows the vehicle component according to this embodiment. FIG. 3 is a cross section of the vehicle component formed by the method for manufacturing the vehicle component according to this embodiment.

The method for manufacturing a vehicle component according to this embodiment (hereinafter also simply referred to as a manufacturing method) is suitable for manufacturing, as a vehicle component 1, a bumper of an automobile like the one shown in FIG. 1. However, the vehicle component 1 may also be a rocker molding, a body, etc.

Firstly, a substrate 2 is formed (S1). For example, the substrate 2 is formed by pouring a resin into a die(s). It should be noted that when a large number of vehicle components 1 are manufactured, it is possible to mold substrates 2 by pouring a resin into a metallic die(s). Further, when a small number of vehicle components 1 are manufactured, it is possible to cast-mold substrates 2 as urethane-based resin molded articles by pouring a resin (e.g., a mixed material of polyol and isocyanate) into a die(s) made of silicon rubber, chemical wood, or the like. Note that the substrate 2 may also be formed by a 3D printer or the like. That is, its formation method is not limited to any particular methods. Further, the material for the substrate 2 is also not limited to any particular materials.

Next, a coating layer 3 is formed so as to cover the surface of the substrate 2 (i.e., is formed on the substrate 2). Specifically, the coating layer 3 includes a surfacer layer 4, a silver mirror layer 5, and a top coat layer 6. First of all, the surfacer layer 4 is formed so as to cover the surface of the substrate 2 (S2).

The surfacer layer 4 is a base layer for the silver mirror layer 5 and the top coat layer 6. It is possible to select a material used for an ordinary surfacer, upon consideration of this material's property of adhesiveness to the substrate 2 and the silver mirror layer 5, as a material for the surfacer layer 4 as appropriate.

Specifically, for example, the surfacer layer 4 can be formed on the surface of the substrate 2 by spray-coating the substrate 2 with a mixed material obtained by adding, as a solvent, titanium oxide, petroleum naphtha, trimethylbenzene, ethyl alcohol, butyl acetate, etc. in a special synthetic resin, i.e., a material used for an ordinary surfacer. Alternatively, the surfacer layer 4 may be formed by an electrodeposition coating method.

Next, a silver mirror layer 5 is formed so as to cover the surface of the surfacer layer 4. The silver mirror layer 5 includes an undercoat part 5a and a silver mirror part 5b. Further, the silver mirror layer is formed on the surface of the surfacer layer 4 in order to make the coating layer 3 shiny. The silver mirror layer 5 can be formed by, for example, a silver-mirror plating method.

Specifically, firstly, an undercoat part 5a is formed so as to cover the surface of the surfacer layer 4 (S3). The undercoat part 5a is a base layer for the silver mirror part 5b. Further, it is possible to select a material used for an undercoat in an ordinary silver-mirror plating method as a material for the undercoat part 5a as appropriate.

For example, the undercoat part 5a can be formed on the surface of the surfacer layer 4 by spray-coating the surfacer layer 4 with a mixed material obtained by adding, as a solvent, methyl methacrylate, toluene, xylene, ethylbenzene, isobutyl acetate, styrene, etc. in an acrylic resin, i.e., a material used for an undercoat in an ordinary silver-mirror plating method.

Next, a silver mirror part 5b is formed so as to cover the surface of the undercoat part 5a (S4). For example, an activation process is performed on the surface of the undercoat part 5a by spray-coating the undercoat part 5a with a hydrochloric-acid acidic solution containing stannous ions or palladium ions, so that the stannous ions or the palladium ions are adsorbed on the surface of the undercoat part 5a.

Then, after washing out the left-over activation solution with water, a silver mirror film is formed by spray-coating the undercoat part 5a with a silver-mirror plating solution composed of, for example, a silver ammonia solution and a reducing agent. After that, it is washed with deionized water and then dried, so that a silver mirror part 5b is formed. Alternatively, the silver mirror layer 5 may be formed by an ordinary electroplating method.

Next, a top coat layer 6 is formed so as to cover the surface of the silver mirror layer 5. The top coat layer 6 includes a first top coat part 6a, a colored top coat part 6b, and a second top coat part 6c. Further, the top coat layer 6 is formed on the surface of the silver mirror layer 5 in order to protect the silver mirror layer 5 and to color the surface of the substrate 2.

Specifically, firstly, the first top coat part 6a is formed so as to cover the surface of the silver mirror part 5b (S5). The first top coat part 6a is formed on the surface of the silver mirror part 5b in order to increase the adhesion property of the colored top coat part 6b to the silver mirror part 5b.

Regarding the first top coat part 6a, with consideration of its adhesion property to the silver mirror part 5b and the colored top coat part 6b, it is possible to select a material used for an ordinary top coat as a material for the first top coat part 6a as appropriate.

For example, the first top coat part 6a can be formed on the surface of the silver mirror part 5b by spray-coating the silver mirror part 5b with a mixed material obtained by adding, as a solvent, xylene, ethylbenzene, n-butyl acetate, isobutyl acetate, etc. in an acrylic resin, i.e., a material used for an ordinary top coat.

Next, a colored top coat part 6b is formed so as to cover the surface of the first top coat part 6a (S6). The colored top coat part 6b colors the surface of the substrate 2 and prevents sunlight from being incident on the silver mirror part 5b.

Regarding colored top coat part 6b, with consideration of its adhesion property to the first and second top coat parts 6a and 6c, and the like, it is possible to select a material used for an ordinary top coat and a material used for ordinary paint as materials for the colored top coat part 6b as appropriate.

For example, the colored top coat part 6b can be formed on the surface of the first top coat part 6a by spray-coating the first top coat part 6a with a mixed material obtained by adding a solvent and a material used for ordinary paint in the same material as that for the first top coat part 6a.

As described above, since the colored top coat part 6b is formed on the surface of the silver mirror part 5b with the first top coat part 6a interposed therebetween, it is possible to improve the adhesion property of the colored top coat part 6b to the surface of the silver mirror part 5b as compared to the case where a paint layer is formed directly on the surface of the silver mirror part 5b.

In addition, when the colored top coat part 6b contains the same material as that for the first top coat part 6a, it is possible to improve the adhesion property between the first top coat part 6a and the colored top coat part 6b.

Note that the weight ratio of the material for the top coat (e g , a material used for an ordinary top coat) and the material for the paint (e.g., a material used for ordinary paint) can be adjusted as appropriate according to the effect of preventing sunlight from being incident on the silver mirror part 5b, the adhesion property to the first and second top coat parts 6a and 6c, and the like. For example, when the weight of the top coat material is 100, the weight of the material for the paint may be about 20.

Next, a second top coat part 6c is formed so as to cover the surface of the colored top coat part 6b (S7). The second top coat part 6c forms an outermost part of the top coat layer 6 and is formed on the surface of the colored top coat part 6b in order to protect the surface of the coating layer 3.

Regarding second top coat part 6c, with consideration of its scratch resistance and its adhesion property to the colored top coat part 6b, and the like, it is possible to select a material used for an ordinary top coat as a material for the second top coat part 6c as appropriate.

For example, the second top coat part 6c can be formed on the surface of the colored top coat part 6b by spray-coating the colored top coat part 6b with a mixed material obtained by adding, as a solvent, toluene, methyl isobutyl ketone, cyclohexanone, etc. in a polyalloy resin, i.e., a material used for an ordinary top coat.

As described above, it is possible to manufacture the vehicle component 1 in which, from the substrate 2 side, the surfacer layer 4, the undercoat part 5a, the silver mirror part 5b, the first top coat part 6a, the colored top coat part 6b, and the second top coat part 6c are laminated on one another in this order.

As described above, in the vehicle component 1 according to this embodiment and the method for manufacturing the vehicle component 1, the colored top coat part 6b is formed on the surface of the silver mirror layer 5. Therefore, it is possible to prevent sunlight from being incident on the silver mirror layer 5, and thereby preventing ultraviolet light and the like from being incident on the silver mirror layer 5. Therefore, the vehicle component 1 and the method for manufacturing the vehicle component 1 can suppress the deterioration of the silver mirror layer 5.

In addition, in the vehicle component 1 and the method for manufacturing the vehicle component 1, since the silver mirror layer 5 is formed on the surface of the substrate 2, it is possible to suppress the transfer of heat to the substrate 2. Further, in the vehicle component 1 and the method for manufacturing the vehicle component 1, since the top coat layer 6 is formed on the surface of the substrate 2, it is possible to prevent the surface of the vehicle component 1 from being scratched.

Therefore, in this embodiment, it is possible to provide the vehicle component 1 having excellent heat resistance, excellent optical resistance, and excellent scratch resistance, and the method for manufacturing the vehicle component 1.

It should be noted that the second top coat part 6c preferably has higher elasticity than that of the first top coat part 6a. As a result, when the second top coat part 6c is pressed, it is elastically deformed in a satisfactory manner. Therefore, it is possible to prevent the surface of the second top coat part 6c from being scratched.

Meanwhile, the first top coat part 6a and the colored top coat part 6b are preferably elastic so that the first top coat part 6a and the colored top coat part 6b are prevented from being permanently deformed when a polishing process is performed on the surfaces of the first top coat part 6a and the colored top coat part 6b in order to make them smooth after the formation of the first top coat part 6a and the colored top coat part 6b. As a result, it is possible to satisfactorily perform the polishing process on the surfaces of the first top coat part 6a and the colored top coat part 6b.

Further, the thickness of the second top coat part 6c is preferably larger than those of the first top coat part 6a and the colored top coat part 6b. For example, the thickness of the first top coat part 6a may be about 20 μm and the thickness of the colored top coat part 6b may be about 20 μm. Further, the thickness of the second top coat part 6c may be about 30 μm.

As a result, it is possible to quantitatively increase the elastic deformation of the second top coat part 6c as compared to the case where the thickness of the second top coat part 6c is equal to that of the first top coat part 6a. As a result, it is possible to suppress the transfer of an external force to the colored top coat part 6b and the like, which are located below the second top coat part 6c and closer to the substrate 2, and thereby to satisfactorily protect the colored top coat part 6b and the like. However, as long as the second top coat part 6c can be elastically deformed in a satisfactory manner, no restriction may be imposed on the relation between the thickness of the first top coat part 6a and that of the colored top coat part 6b.

Further, in this embodiment, since the substrate 2 is formed by the casting-molding method and the silver mirror layer 5 is formed by the silver-mirror plating method, a small number of vehicle components 1 can be manufactured at a low cost.

In particular, although a urethane-based resin molded article formed by casting-molding has a low heat-resistance temperature, it is possible to suppress the transfer of heat to the substrate 2, which is a urethane-based resin molded article, by forming the silver mirror layer 5 on the surface of the substrate 2. As a result, it is possible to suppress the rise in the temperature of the substrate 2. Therefore, it is possible to use a urethane-based resin molded article formed by the casting-molding method as the substrate 2 in a satisfactory manner.

In addition, although the substrate 2 formed by casting-molding has a low heat-resistance temperature as described above, it is possible to form the silver mirror layer 5 in a satisfactory manner while suppressing the rise in the temperature of the substrate 2 by using the silver-mirror plating method for the formation of the silver mirror layer 5.

Note that although the top coat layer 6 according to this embodiment is formed by the spray-coating method, it can be formed by selecting an ordinary coating method as appropriate according to the material used for the substrate 2, the property of the silver mirror layer 5, etc.

### Second Embodiment

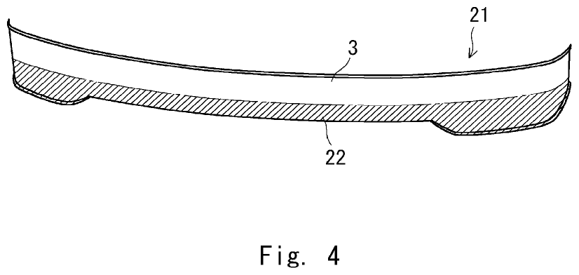

In the first embodiment, the coating layer 3 including the silver mirror layer 5 and the top coat layer 6 is formed over the entire surface of the vehicle component 1 as shown in FIG. 2. However, the present disclosure is not limited to this structure. FIG. 4 schematically shows a vehicle component according to this embodiment.

As shown in FIG. 4, the vehicle component 21 according to this embodiment has a structure in which the coating layer (the first coating layer) 3 including the silver mirror layer 5 and the top coat layer 6 according to the first embodiment is formed on a part of the surface of the vehicle component 21. Further, a second coating layer 22 is formed on the other part of the surface of the vehicle component 21. Note that in FIG. 4, the part where the second coating layer 22 is formed is indicated by hatching and the border between the first and second coating layers 3 and 22 is indicated by a dashed line.

In this case, firstly, masking is applied to the other part of the surface of the vehicle component 21. After that, through a flow similarly to the flow through which the coating layer 3 is formed in the first embodiment, the first coating layer 3 is formed on the part of the surface of the vehicle component 21.

Next, the masking covering the other part of the surface of the vehicle component 21 is removed and masking is applied to the part of the surface of the vehicle component 21 (i.e., the part on which the first coating layer 3 has been formed). Then, the second coating layer 22 is formed on the other part of the surface of the vehicle component 21. The second coating layer 22 may be an ordinary coating layer or a plating layer.

As described above, in this embodiment, it is possible to easily apply the first and second coating layers 3 and 22 to their respective parts of the surface of the vehicle component 21.

Note that although the second coating layer 22 is formed after the formation of the first coating layer 3 in this embodiment, the first coating layer 3 may be formed after the formation of the second coating layer 22.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A vehicle component comprising a silver mirror layer and a top coat layer formed on a substrate, wherein
the top coat layer comprises:
a first top coat part formed on the silver mirror layer;
a second top coat part forming an outermost part of the top coat layer; and
a colored top coat part disposed between the first and second top coat parts, the colored top coat part being mixed with paint.

2. The vehicle component according to claim 1, wherein the second top coat part has higher elasticity than that of the first top coat part.

3. A method for manufacturing a vehicle component comprising a silver mirror layer and a top coat layer formed on a substrate, the method comprising:
when the top coat layer is formed,
forming a first top coat part on the silver mirror layer;
forming a colored top coat part on the first top coat part, the colored top coat part being mixed with paint; and
forming, as an outermost part of the top coat layer, a second top coat part on the colored top coat part.

4. The method for manufacturing a vehicle component according to claim 3, wherein the substrate is a cast-molded article molded from a urethane-based resin.

5. The method for manufacturing a vehicle component according to claim 3, wherein the silver mirror layer is formed by a silver-mirror plating method.

6. The method for manufacturing a vehicle component according to claim 3, wherein the silver mirror layer and the top coat layer are formed on a part of the substrate, and another coating is applied to another part of the substrate.
